(19) United States
(12) Patent Application Publication
(10) Pub. No.: US 2026/0178732 A1
(43) Pub. Date: Jun. 25, 2026

(54) Anomaly Detection Using Spatial Voting, Machine Learning, And Power Management Framework On An Embedded Neural Processing Unit

(71) Applicant: Advanced Micro Devices, Inc., Santa Clara, CA (US)

(72) Inventors: Brandon Cellic Woolley, Austin, TX (US); Mahesh Subramony, Austin, TX (US)

(21) Appl. No.: 18/987,905

(22) Filed: Dec. 19, 2024

(51) Int. Cl. G06F 21/56

(52) U.S. Cl. CPC G06F 21/56; G06F 2221/034

(57) ABSTRACT

An apparatus and method for efficiently detecting attacks attempting access of user private information. In various implementations, a computing system includes a computing device with first circuitry that executes instructions of an operating system and commands from the operating system. The computing device also includes second circuitry that executes instructions of one or more sources of code, such as instructions of an anomaly detection driver, instead of the operating system. The first circuitry could become infected with malware, whereas the second circuitry is isolated from malware. The specialized circuitry collects data indicating hardware behavior of the computing system and generates, based on the collected data, an indication specifying whether an anomaly has occurred in the computing system.

### BACKGROUND

### Description of the Relevant Art

Users rely on a variety of types of computing devices such as desktop computers, server computers, laptop computers, smartphones, gaming devices, and so on. These computing devices are used for web browsing, financial management and financial transactions, and other activities that include user private information. Accordingly, the security of these computing devices, and their ability to detect attacks that compromise user private information has become increasingly important. An “anomaly” is a deviation by at least a threshold amount (or multiple thresholds) from expected hardware behavior of the computing device. Detection of anomalies is used to determine whether an attack has occurred on the computing device. While a variety of approaches exist to detect anomalous behavior in a computing system that might indicate an attack, these approaches often degrade system performance in undesirable ways.

In view of the above, methods and mechanisms for efficiently detecting attacks on a client device are desired.

### BRIEF DESCRIPTION OF THE DRAWINGS

FIG. 1 is a generalized diagram of data processing used for efficient detection of attacks on a client device.

FIG. 2 is a generalized diagram of grid data used for efficient detection of attacks on a client device.

FIG. 3 is a generalized diagram of a data model used for efficient detection of attacks on a client device.

FIG. 4 is a generalized diagram of a method for efficiently detecting attacks on a client device.

FIG. 5 is a generalized diagram of a computing system used for efficient detection of attacks on a client device.

FIG. 6 is a generalized diagram of a method for efficiently detecting attacks on a client device.

FIG. 7 is a generalized diagram of a method for efficiently detecting attacks on a client device.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods for efficiently detecting attacks on a client device are disclosed herein. In various implementations, a computing system of a client device includes first circuitry that executes instructions of an operating system and commands from the operating system. Examples of the client device are a laptop computer, a smartphone, a gaming console, a server computer, a desktop computer, or otherwise. The first circuitry includes a host processing circuit, such as a general-purpose central processing unit (CPU), and a parallel data processing circuit with a highly parallel data microarchitecture, such as a graphics processing unit (GPU). The second circuitry includes a multiprocessing circuit or other circuitry different from the CPU and the GPU. The second circuitry is isolated from operating system software being executed by at least the CPU of the first circuitry.

The second circuitry is configured to execute instructions of an anomaly detection driver. While the first circuitry could become infected with malware, the second circuitry is isolated from malware. The second circuitry collects telemetry data. As used herein, the “telemetry data” includes data that indicates hardware behavior of the computing system. Examples of telemetry data are measurements of power consumption and hardware events that occur over time as the first circuitry executes tasks. In some implementations, the telemetry data includes power consumption data such as one or more of an operating temperature, an operating power supply voltage and current drawn by the first circuitry. In an implementation, the hardware events include data stored in performance counters corresponding to one or more of cache misses at one or more levels of a cache hierarchy, a number of instructions retired, and a number of bytes read from or written to a memory controller. The second circuitry generates, based on the collected telemetry data, a prediction that an anomaly has occurred in the computing system.

Typically, computing systems rely on software tools and instrumented code for detecting anomalies. However, the first circuitry executing the operating system, executing the software tools and executing the instrumented code is susceptible to malware. Additionally, detection mechanisms that rely on software tools can report late a prediction that malware has executed on the first circuitry. In various implementations, the computing device does not rely on software tools for detecting anomalies. For anomaly detection, the computing device also does not rely on third party solutions that can create overhead. Rather, the computing device relies on the second circuitry that is isolated from malware that can execute on the first circuitry. To achieve isolation, the second circuitry does not execute instructions of the operating system. In some implementations, the second circuitry includes one or more of an embedded inference processing unit (EIPU) or an embedded inference processing circuit, an artificial intelligence (AI) accelerator processing circuit, an embedded neural processing unit (NPU) or an embedded neural processing circuit, a multiprocessing circuit, and so on. By using the second circuitry for anomaly detection, the proposed solution is isolated from malware effects.

Based on this collected telemetry data indicating hardware behavior of the computing system, the second circuitry organizes the collected data and uses a spatial voting algorithm to divide the data of the first format into multiple spatial regions and assign a vote to each spatial region based on the collected data in a corresponding spatial region. The second circuitry generates a score or other indication specifying a probability that an anomaly has occurred in the spatial region based on a vote exceeding a corresponding threshold in one or more spatial regions of the multiple spatial regions. In some implementations, one or more regions include one or more colored squares indicating a number of statistical features pairs corresponding to the power telemetry data mapped to the region.

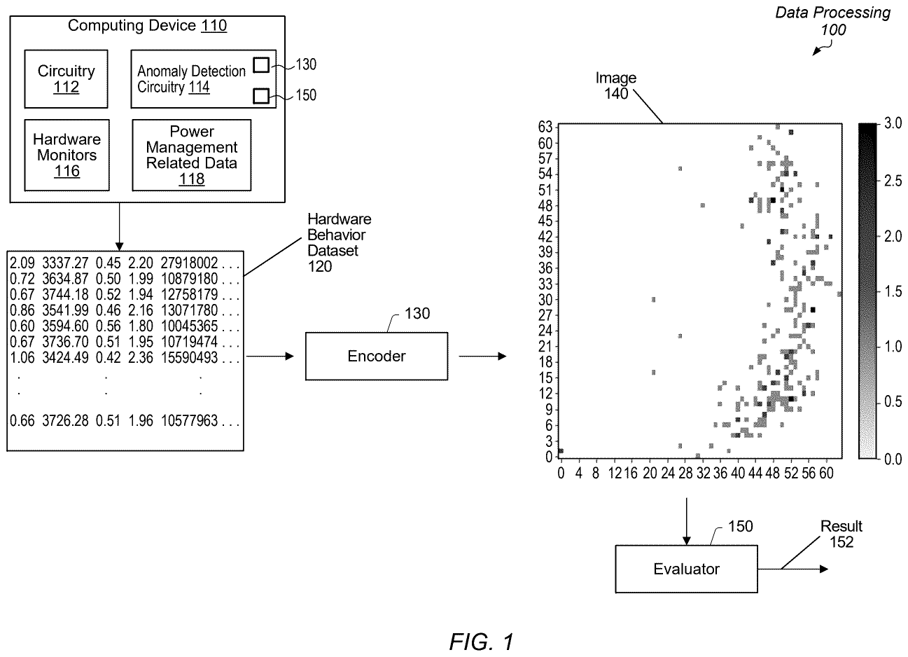

To generate the prediction (score or other indication) of whether an anomaly has occurred, the second circuitry conveys the image to an image recognition based neural network structure. The neural network structure has been trained to recognize anomalies in images that depict statistical information. When executing the instructions of the neural network structure, the second circuitry generates the prediction that malware has executed on the first circuitry. If a potential anomaly is detected, the second circuitry generates an alert to send to the first circuitry. The alert includes data that provides information about the nature of the anomaly, the location of the anomaly in the multiple spatial regions, and suggested actions to resolve the anomaly. Further details of these techniques to perform efficient detection of attacks attempting access of user private information are provided in the following description of FIGS. 1-7.

Turning now to FIG. 1, a generalized diagram is shown of data processing 100 used for efficient detection of attacks on a client device. The attacks can, for example, be seeking access to private user information, or otherwise. In various implementations, computing device 110 includes anomaly detection circuitry 114 that generates data to input to an evaluator 150. The evaluator 150 can also be referred to as an anomaly detection circuit. Evaluator 150 generates result 152 that indicates whether an anomaly has occurred in the computing device 110 as circuitry 112 executes tasks of one or more workloads. Examples of computing device 110 are a laptop computer, a smartphone, a gaming console, a server computer, a desktop computer, or otherwise. Evaluator 150 receives data that characterizes the hardware behavior of computing device 110 instead of receiving data collected and analyzed by software tools. For example, hardware behavior dataset 120 (or dataset 120) includes indications from hardware monitors 116 such as hardware performance counters located across computing device 110. In some implementations, dataset 120 also includes indications from power management related data 118 that include measurements of the operating temperature of multiple regions of computing device 110 and the amount of current drawn by one or more integrated circuits and processing circuits of computing device 110. Therefore, result 152 generated by evaluator 150 utilizes indications of hardware behavior of computing device 110.

As used herein, an “anomaly” is a deviation by at least a threshold amount (or multiple thresholds) from expected hardware behavior of computing device 110. To define the hardware behavior of computing device 110, multiple data points indicating measurements of hardware behavior are collected, organized, and analyzed such as comparing the collected data points or values to one or more thresholds. An anomaly can be used to identify possible suspicious activity performed by computing device 110. This suspicious activity can be a malicious act performed by malware. Malware is software that is unintentionally installed on computing device 110 by a user or intentionally installed by an attacker without knowledge by the user. This software attempts to access user private information stored in computing device 110 or stored in a peripheral memory connected to computing device 110 without the user's consent. The malware uses a variety of tactics to attempt the accesses and provide an attacker with the user private information.

Typically, malware detection relies on software tools. Using software tools, malware detection can include scanning one or more of the content, signatures, and heuristics of source code of applications. These types of methods rely on developer knowledge of the type of files used by the applications. Other methods include sending collected characteristics of the applications to a remote server or organizational center with a database to determine whether malware is present on the computing device 110. In contrast, data processing 100 utilizes at least local measurements of hardware behavior to detect anomalies in computing device 110.

Computing device 110 includes circuitry 112 that executes instructions of an operating system and commands from the operating system. Examples of circuitry 112 are a general-purpose processing circuit, such as a central processing unit (CPU), and a parallel data processing circuit with a highly parallel data microarchitecture, such as a graphics processing unit (GPU). Other types of processing circuits or integrated circuits of the first circuitry are a digital signal processing circuit (DSP), a field programmable gate arrays (FPGA), an application specific integrated circuit (ASIC), input/output (I/O) peripheral devices and controllers, fixed-function integrated circuits, and so forth. Circuitry 112 executes tasks of a variety of types of workloads.

Computing device 110 also includes anomaly detection circuitry 114 (or circuitry 114) that is isolated from operating system software being executed by the CPU of circuitry 112. In this sense, anomaly detection circuitry 114 is configured to execute instructions of code instead of the operating system such as instructions of an anomaly detection driver. In some implementations, circuitry 114 includes one or more of an embedded inference processing unit (EIPU) or an embedded inference processing circuit, an artificial intelligence (AI) accelerator processing circuit, an embedded neural processing unit (NPU) or an embedded neural processing circuit, a multiprocessing circuit, and so on.

Circuitry 114 collects data indicating hardware behavior of computing device 110. To do so, as described earlier, circuitry 114 receives collected data stored in hardware monitors 116 located across one or more integrated circuits and processing circuits of computing device 110. These hardware monitors store counts, rates, or other measurements of particular hardware events that occur over time across the computing system. Examples of these hardware events are a number of cache misses at one or more levels of a cache hierarchy, a number of accesses at the one or more levels of a cache hierarchy, a number of page table walks by a processing circuit, a number of instructions fetched, decoded, or retired of a particular instruction type by a processing circuit, a number of micro-operations (micro-ops) retired by a processing circuit where the micro-ops are generated from instructions, a number of branch mispredictions by a processing circuit, a number of bytes read from or written to memory controllers, a number of stalls in a particular pipeline stage of a processing circuit, and so forth. The types of information captured by the hardware monitors 116 vary from one type of processing circuit or integrated circuit to another due to the differences in the microarchitectures.

In some implementations, circuitry 114 also receives power management related data 118. Power management related data 118 includes measurements from one or more sensors located across one or more integrated circuits and processing circuits of computing device 110. These sensors measure various operating parameters. In various implementations, these operating parameters include the operating temperature of multiple regions of the computing device 110, the amount of current drawn by one or more integrated circuits and processing circuits of the computing device 110, the power supply voltage used by one or more integrated circuits and processing circuits of the computing device 110, and so forth.

Power management related data 118 can also include a measure of utilization of one or more integrated circuits and processing circuits. Power management related data 118 can also include a power-performance state (P-state) of one or more integrated circuits and processing circuits. The P-state includes an indication (e.g., P0, P1, and so on) that indicates at least an operating power supply voltage and an operating clock frequency of a corresponding integrated circuit. In other implementations, circuitry 114 receives power management related data from remote servers storing telemetry data of multiple computing devices. In some implementations, the multiple computing devices use the same computing system or architecture. In an implementation, the remote server is one of multiple servers supporting a database located at a datacenter. This data is monitored by multiple computing devices and sent as telemetry messages to the remote servers. Circuitry 114 accesses the power management related data from the remote servers via a network connection and includes it as collected data indicating hardware behavior of the computing device 110. The combination of the directly accessible (or local) power management related data and the remotely accessed power management related data provides a power management framework for circuitry 114 to indicate hardware behavior of the computing device 110.

In an implementation, circuitry 114 retrieves the above data indicating hardware behavior of computing device 110 responsive to detecting a period of time has elapsed. An indication of the period of time is stored in a programmable configuration register. In another implementation, circuitry 114 retrieves the data indicating hardware behavior responsive to detecting an event such as a P-state change. The indication of the P-state identifies an operating power supply voltage and an operating clock frequency for one or more processing circuits, controllers, or interface circuits. A power manager (not shown) generates the indication of the P-state for different components across computing device 110 based on one or more of collected activity levels of the components, an operating temperature of computing device 110, a number of power credits allocated to the components, and so on.

Based on this collected data indicating hardware behavior of the computing device 110, when executing the instructions of an anomaly detection driver, circuitry 114 organizes the collected data into as rows and columns based on the information type as illustrated by dataset 120. Each type of information has a location reserved for it in a column of each row. The values placed in dataset 120 can be floating-point numbers, integers, Boolean values or otherwise, based on the design requirements and the type of information being monitored. The numerical formats of the original collected data can be reformatted when placed in dataset 120. The meaning of each location among the rows and columns of dataset 120 is known by encoder 130.

When executing the instructions of an anomaly detection driver, circuitry 114 uses encoder 130 to perform spatial voting techniques on dataset 120, which generates one or more unique statistical features per row of dataset 120. In an implementation, encoder 130 utilizes techniques of one of a variety of types of a spatial voting algorithm. Examples of the statistical features are a running mean (RM), a running sigma (SM), and so forth. Different equations are used for each of the statistical features based on design requirements. The running mean and the running sigma can be used to indicate how well the particular row of data of dataset 120 meets expectations of hardware behavior as circuitry 112 executes tasks of one or more workloads. In an implementation, a running mean and a running sigma are calculated for each column of the particular row. In another implementation, two or more columns of data are combined and have a corresponding running mean and running sigma calculated for it. A sigma level measures the number of standard deviations from the mean for the particular row of data of dataset 120 or for particular one or more columns of the particular row. Sigma levels can be used to measure deviations from expected behavior with higher sigma levels indicating expected hardware behavior of circuitry 112 as circuitry 112 executes tasks.

Using encoder 130, circuitry 114 generates a moving average for dataset 120. The moving average for a particular row of dataset 120 uses data stored in the particular row and one or more other rows of dataset 120. Each row is generated based on the elapsed time period or occurrence of an event such as a P-state change. Therefore, each row is generated at a corresponding point in time. In some implementations, multiple rows adjacent to the particular row are selected for determining the moving average. In other implementations, one or more rows non-adjacent to one another are selected to be combined to form the moving average with the particular row. The moving average filters out fluctuations of the rows of the dataset to better assess whether anomalies are occurring as circuitry 112 executes tasks. The statistical features provide a pair of values. Each of the generated statistical features is mapped to an axis of a spatial voting grid as illustrated in image 140. In an implementation, the x-axis of image 140 measures running mean statistics or running mean variation over time and the y-axis of image 140 measures running sigma statistics or running deviation variation over time.

Image 140 is an N×M grid where each of N and M is a positive, non-zero integer. In some implementations, M is equal to N. In some implementations, encoder 130 generates two order-dependent statistical values (a pair) based on values in one or more rows of dataset 120. These two order-dependent statistic values are referred to as two extracted features, and using encoder 130, circuitry 114 maps each of the two extracted features to a corresponding axis of a spatial voting N×M grid. Image 140 illustrates an implementation of the spatial voting N×M grid. Image 140 includes multiple cells identified by coordinates on the x-axis and the y-axis. The two order-dependent statistical values are used to identify one of the N×M cells or regions.

In the illustrated implementation, image 140 is a spatial voting 64×64 grid. Image 140 provides a latent space mathematical representation of dataset 120 where similar characteristics (hardware events) are grouped, making image 140 a useful input to a data model trained in image recognition. When executing the instructions of an anomaly detection driver, circuitry 114 assigns a vote to each spatial region (cell) in image 140. A “vote” can also be referred to as a “count.” Circuitry 114 generates a score or other indication specifying a probability that an anomaly has occurred in the spatial region (cell) based on one or more votes (or counts) exceeding a corresponding threshold in one or more spatial regions of the multiple spatial regions. In some implementations, circuitry 114 utilizes evaluator 150 to generate the scores and perform the comparisons of the scores with corresponding thresholds. In an implementation, evaluator 150 utilizes a machine learning data model (or data model). The data model uses machine learning techniques that rely on one of an autoencoder (AE) deep neural network (DNN) structure, a recurrent neural network (RNN) structure, a convolutional neural network (CNN) structure, a deep neural network (DNN) structure, and so forth.

When executing the instructions of an anomaly detection driver, encoder 130 of circuitry 114 generates image 140 by encoding the dataset 120 as an image that includes data points across multiple regions. For data values of dataset 120 corresponding to one or more columns in a particular row and one or more additional rows (adjacent or non-adjacent depending on the implementation), encoder 130 generates a first coordinate corresponding to a running mean of the subset of data values. Encoder 130 generates a second coordinate corresponding to a running standard deviation (or running sigma level depending on the implementation) of the subset of data values. Encoder 130 increments a count corresponding to the region of the multiple regions of image 140 located by the first coordinate and the second coordinate.

In an implementation, when executing the instructions of an anomaly detection driver, evaluator 150 of circuitry 114 adjusts the counts of the multiple regions utilizing multiple weights assigned to one or more of the corresponding subset of data values and the counts. Evaluator 150 retrieves multiple thresholds corresponding to one or more images generated with no malware running on circuitry 112. In some implementations, the weights and the thresholds have values found during training of the data model when a data model is used. In some implementations, the circuitry of evaluator 150 generated weights during training of the neural network structure that utilizes unsupervised learning. The training used multiple images based on statistical features of the telemetry data collected over time. Therefore, the neural network structure has been trained to recognize anomalies in images that depict statistical information.

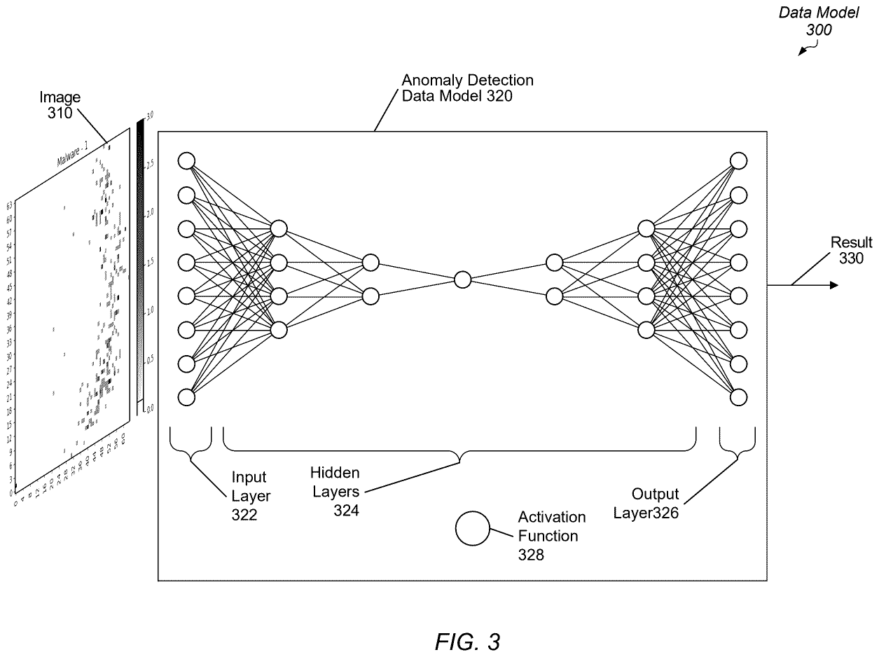

When executing the instructions of the neural network structure (e.g., autoencoder (AE) deep neural network (DNN) structure or other), evaluator 150 conveys image 140 to the image recognition based neural network structure. When executing the instructions of the neural network structure, evaluator 150 generates the prediction that malware has executed on circuitry 112. If a potential anomaly is detected, evaluator 150 generates an alert as result 152 to send to circuitry 112. The alert includes data that provides information about the nature of the anomaly, the location of the anomaly in the multiple spatial regions, and suggested actions to resolve the anomaly. Further details are provided in the description of data model 300 (of FIG. 3).

In some implementations, circuitry 114 uses multiple data models with each of the multiple data models including a different type of neural network structure. Circuitry 114 combines the results of one or more data models to generate one or more indications specifying whether an anomaly has occurred as circuitry 112 executes tasks of one or more workloads. In an implementation, circuitry 114 generates one or more weight sums using the results of the multiple data models and compares the weight sums to one or more thresholds. In another implementation, circuitry 114 combines the results using one of multiple other types of calculations. If a potential anomaly is detected, circuitry 114 generates an alert to send to circuitry 112. The alert includes information about the nature of the anomaly, the location of the anomaly in the multiple spatial regions, and suggested actions to resolve the anomaly.

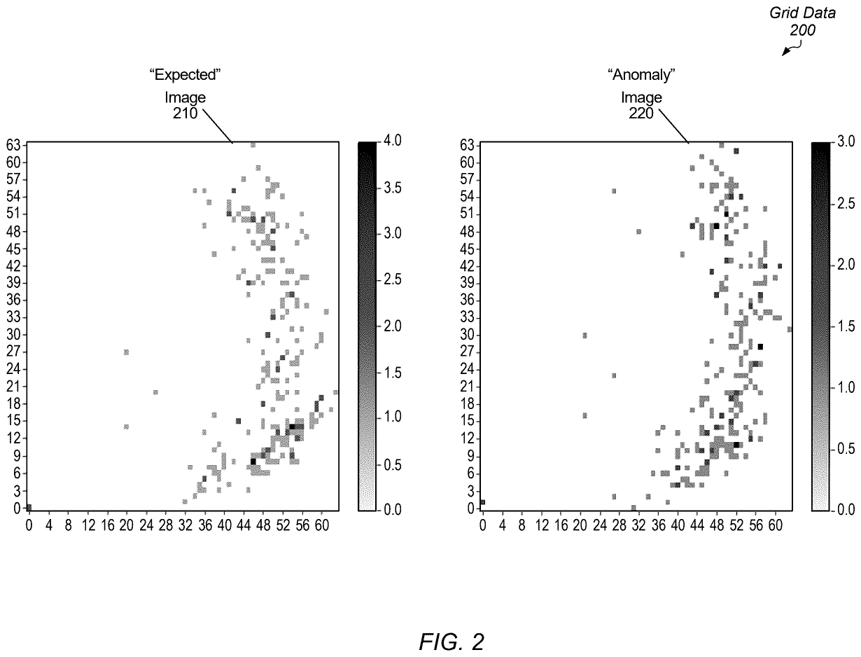

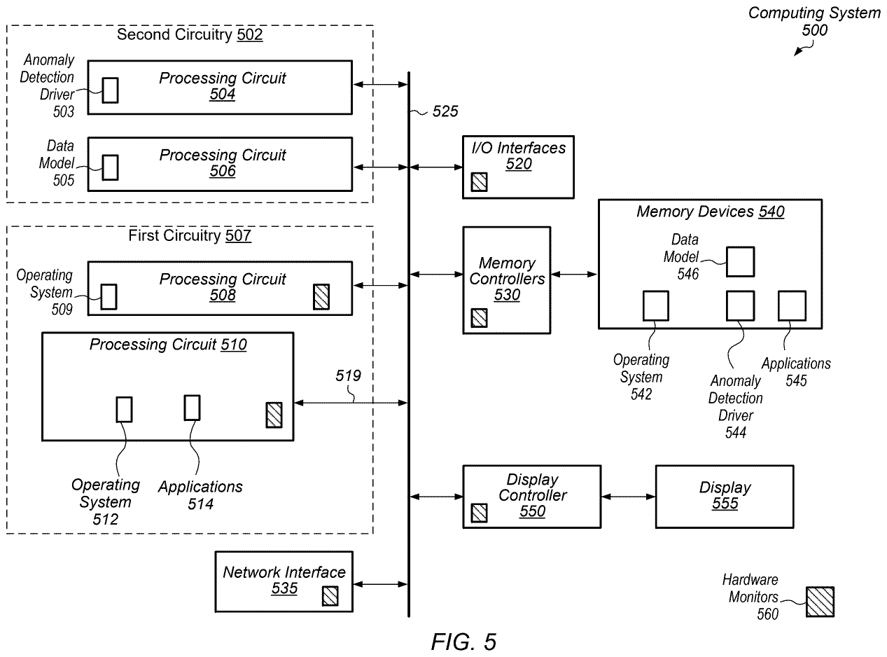

Referring to FIG. 2, a generalized diagram is shown of grid data 200 used for efficient detection of attacks on a client device. The attacks can, for example, be seeking access to private user information, or otherwise. As shown, grid data 200 includes image 210 and image 220. In some implementations, a processing circuit executing an anomaly detection driver generates images 210 and 220 using an encoder. In some implementations, the encoder utilizes one of a variety of types of a spatial voting algorithm. Examples of the processing circuit are processing circuits of circuitry 114 (of FIG. 1) and second circuitry 502 (of FIG. 5). The encoder receives a dataset based on collected data that characterizes the hardware behavior of a corresponding computing device. An example of the dataset is dataset 120 (of FIG. 1).

Each of images 210 and 220 illustrates an implementation of the spatial voting N×M grid. Each of images 210 and 220 includes multiple cells (or regions) identified by coordinates on the x-axis and the y-axis. For data values of the dataset corresponding to one or more columns in a particular row and one or more additional rows (adjacent or non-adjacent depending on the implementation), the encoder generates a first coordinate corresponding to a running mean of the subset of data values. The encoder generates a second coordinate corresponding to a running standard deviation (or running sigma level depending on the implementation) of the subset of data values. The encoder increments a count corresponding to the region of the multiple regions of the corresponding image located by the first coordinate and the second coordinate. The two order-dependent statistic values (first coordinate and second coordinate) generated by the encoder are used to identify one of the N×M cells (or regions). In the illustrated implementation, each of images 210 and 220 is a spatial voting 64×64 grid. Each of images 210 and 220 provides a latent space mathematical representation of a dataset, such as dataset 120 (of FIG. 1), where similar characteristics (hardware events) are grouped, making each of images 210 and 220 a useful input to a data model trained in image recognition.

As shown, images 210 and 220 visually appear similar. Image 220 has a few more data points in different spatial regions (cells) than image 210. However, anomaly detection circuitry generates image 210 on a computing device providing expected hardware behavior. In contrast, anomaly detection circuitry generates image 220 on a computing device infected with malware. An anomaly detection data model can analyze images 210 and 220 and recognize an anomaly better than visual inspection of images 210 and 220.

Referring to FIG. 3, a generalized diagram is shown of data model 300 used for efficient detection of attacks on a client device. The attacks can, for example, be seeking access to private user information, or otherwise. As shown, anomaly detection data model 320 receives image 310 and generates result 330. Similar to image 140 (of FIG. 1) and images 210 and 220 (of FIG. 2), an anomaly processing circuit generates image 310 using a dataset based on collected data that characterizes the hardware behavior of a corresponding computing device. In an implementation, anomaly detection data model 320 (or data model 320) uses an autoencoder (AE) deep neural network (DNN) structure. Although such a neural network structure is described here, it is possible and contemplated that data model 320 uses another neural network structure in other implementations based on design requirements.

Data model 320 can analyze complex non-linear associations. To do so, data model 320 utilizes one or more hidden layers 324 between the input layer 322 and the output layer 326. The input layer 322 includes the initial input variables from image 310. Each of the layers 322, 324 and 326 includes multiple activation nodes (or neurons). Each node receives a product of a weight (not shown) and corresponding input variables, which is multiplied by a weight and the product is summed with other products corresponding to the received input variables. Each of these nodes performs a unit step function, which determines whether the node will be activated. In other words, each of these nodes uses a predetermined activation function indicated as activation function 328. An example of the activation function 328 is the rectified linear (ReLU) activation function, which is a piecewise linear function used to transform a weighted sum of the input variables into the activation of a corresponding node or output. In some implementations, different layers use different activation functions. When activated, the node (or neuron) generates a non-zero value, and when not activated, the node (or neuron) generates a zero value. In some implementations, a “bias” node with a value of 1 is additionally used.

The hidden layers 324 includes one or more additional layers of nodes. In an implementation, hidden layers 324 includes one or more pooling layers to filter outputs of intermediate layers of hidden layers 324, which reduces the computational load inside the hidden layers 324 and prevents over-fitting. A flattening layer in the hidden layers 324 converts the output data of one of the layers to a one-dimensional vector. The output layer 326 generates the result 330. The result 330 includes a score or other indication specifying the probability that an anomaly has occurred in one or more spatial regions of image 310 based on a vote exceeding a corresponding threshold in one or more spatial regions of the multiple spatial regions of image 310. In some implementations, the result 330 is combined by a processing circuit with other information includes identification of the nature of the anomaly, the location of the anomaly in the multiple spatial regions, and suggested actions to resolve the anomaly.

The training process of data model 320 is an iterative process that generates a set of weight values used for mapping the input data received by the input layer 322 to the result 330. The weights can be optimized for a particular system architecture of a computing device and a grid size of images such as image 310. In some implementations, the training process utilizes unsupervised learning where image 310 is provided with no label (expected versus anomaly). Being unsupervised allows for detection of unknown (yet to be identified or classified) types of malware. Using unsupervised learning for the training removes reliance on signatures or heuristics for detections of anomalies. The weights and thresholds used to generate result 330 are calculated from results generated by data model 320 using other images 310, rather than from labels provided by a user.

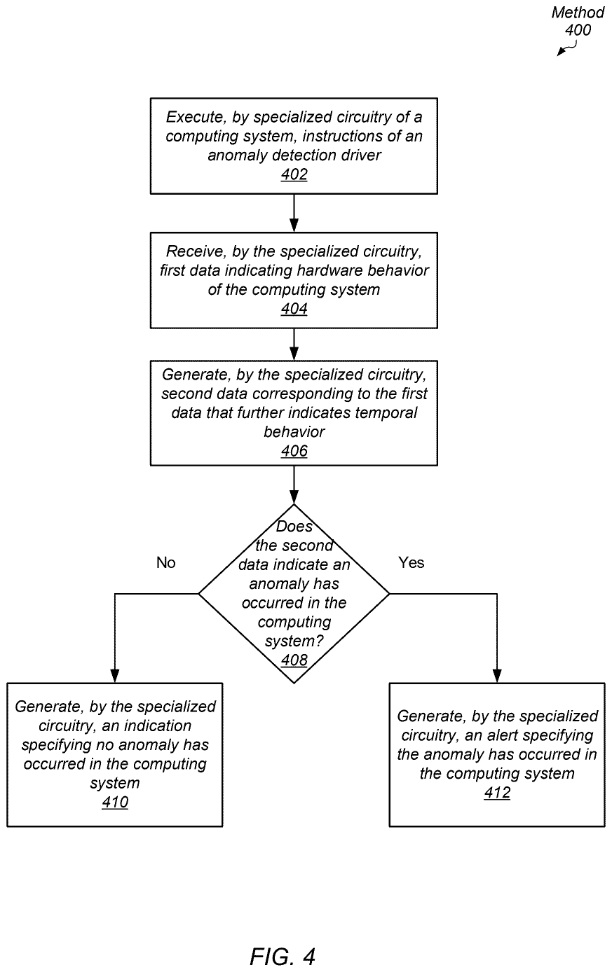

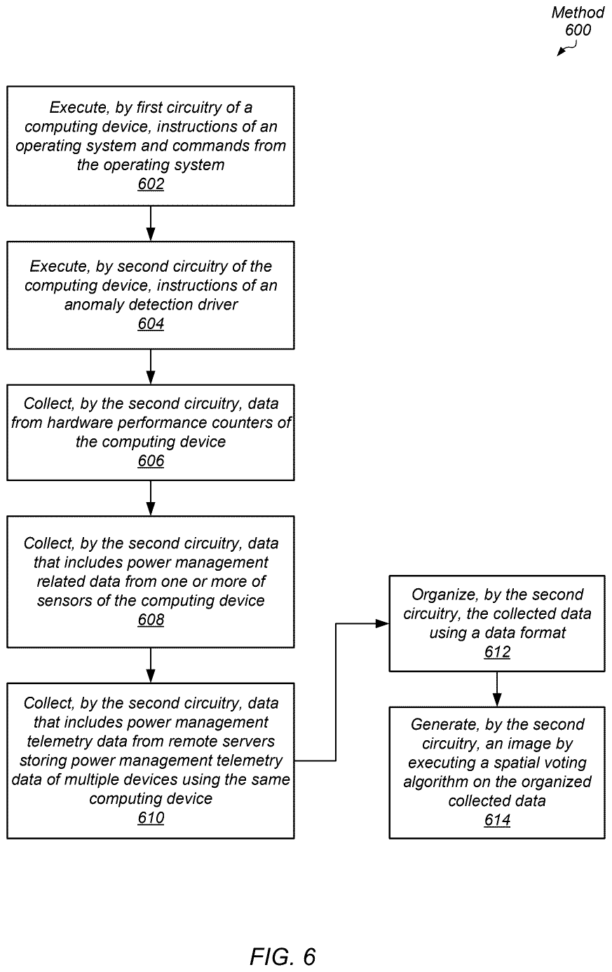

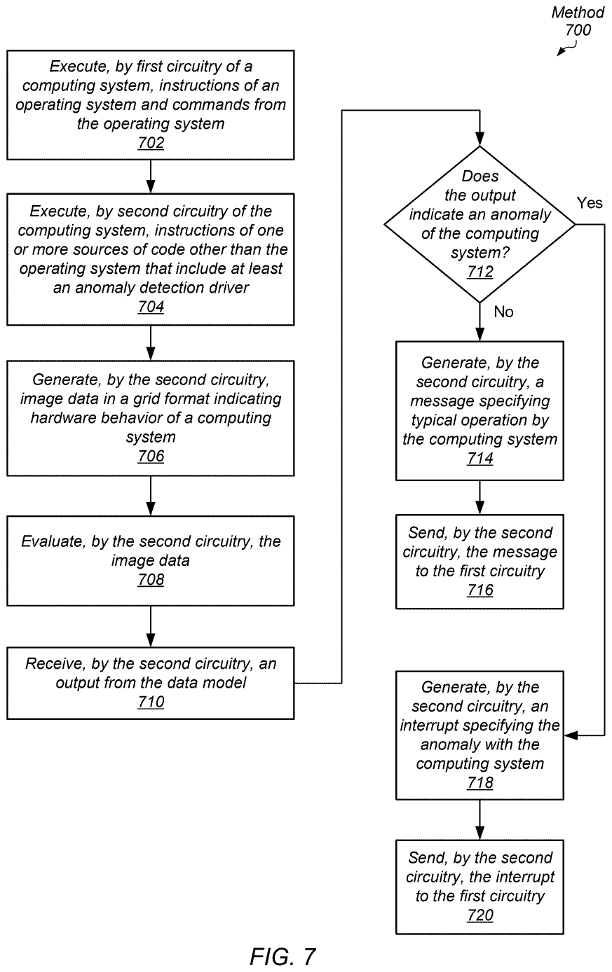

Referring now to FIG. 4, a generalized block diagram is shown of a method 400 for efficiently detecting attacks on a client device. The attacks can, for example, be seeking access to private user information, or otherwise. For purposes of discussion, the steps in this implementation (as well as in FIGS. 6-7) are shown in sequential order. However, in other implementations some steps occur in a different order than shown, some steps are performed concurrently, some steps are combined with other steps, and some steps are absent.

In various implementations, a computing system includes first circuitry that executes instructions of an operating system and commands from the operating system. Examples of the computing device are a laptop computer, a smartphone, a gaming console, a server computer, a desktop computer, or otherwise. Examples of the first circuitry are one or more of a general-purpose processing circuit, such as a central processing unit (CPU), and a parallel data processing circuit with a highly parallel data microarchitecture, such as a graphics processing unit (GPU). Other types of processing circuits or integrated circuits of the first circuitry are a digital signal processing circuit (DSP), a field programmable gate arrays (FPGA), an application specific integrated circuit (ASIC), input/output (I/O) peripheral devices and controllers, fixed-function integrated circuits, and so forth. In various implementations, the first circuitry has the same functionality as circuitry 112 (of FIG. 1) and first circuitry 507 (of FIG. 5). The computing system also includes specialized circuitry that is isolated from operating system software being executed by at least the CPU of the first circuitry. In this sense, the specialized circuitry is configured to execute instructions of code instead of the operating system such as instructions of an anomaly detection driver (block 402). By being isolated from the operating system and executing the instructions of the anomaly detection driver, the specialized circuitry is also isolated from malware targeting the first circuitry.

In various implementations, the specialized circuitry is anomaly detection circuitry. In some implementations, the specialized circuitry includes one or more of an embedded inference processing unit (EIPU) or an embedded inference processing circuit, an artificial intelligence (AI) accelerator processing circuit, an embedded neural processing unit (NPU) or an embedded neural processing circuit, a multiprocessing circuit, and so on. In various implementations, the specialized circuitry has the same functionality as anomaly detection circuitry 114 (of FIG. 1) and second circuitry 502 (of FIG. 5). The specialized circuitry receives first data indicating hardware behavior of the computing system (block 404).

In some implementations, the specialized circuitry receives collected data stored in hardware performance counters (or hardware monitors) located across one or more integrated circuits and processing circuits of the computing system. These hardware monitors store counts, rates, or other measurements of particular hardware events that occur over time across the computing system. Examples of these hardware events are a number of cache misses at one or more levels of a cache hierarchy, a number of accesses at the one or more levels of a cache hierarchy, a number of page table walks by a processing circuit, a number of instructions fetched, decoded, or retired of a particular instruction type by a processing circuit, a number of micro-operations (micro-ops) retired by a processing circuit where the micro-ops are generated from instructions, a number of branch mispredictions by a processing circuit, a number of bytes read from or written to memory controllers, a number of stalls in a particular pipeline stage of a processing circuit, and so forth. The types of information captured by the hardware monitors vary from one type of processing circuit or integrated circuit to another due to the differences in the microarchitectures.

In some implementations, the specialized circuitry also receives power management related data. The power management related data includes measurements from one or more sensors located across one or more integrated circuits and processing circuits of the computing system. These sensors measure various operating parameters. In various implementations, these operating parameters include the operating temperature of multiple regions of the computing system, the amount of current drawn by one or more integrated circuits and processing circuits of the computing system, the power supply voltage used by one or more integrated circuits and processing circuits, and so forth. The power management related data can also include a measure of utilization of one or more integrated circuits and processing circuits. The power management related data can also include a power-performance state (P-state) of one or more integrated circuits and processing circuits. The P-state includes an indication (e.g., P0, P1, and so on) that indicates at least an operating power supply voltage and an operating clock frequency of a corresponding integrated circuit.

In other implementations, the specialized circuitry receives power management related data from remote servers storing power management related data that corresponds to multiple client devices. In various implementations, these client devices have the same architecture while in others they may have different architectures. This data is monitored by multiple client devices and sent as telemetry messages to the remote servers. The specialized circuitry accesses the power management related data from the remote servers and includes it as collected data indicating hardware behavior of the computing system. The combination of the directly accessible power management related data and the remotely accessed power management related data provides a power management framework for the specialized circuitry to indicate hardware behavior of the computing system.

The specialized circuitry generates second data corresponding to the first data that further indicates temporal behavior (block 406). In some implementations, the specialized circuitry organizes the collected first data into a first format such as rows and columns based on the information type. Each type of information has a location reserved for it in the rows and columns of the first format. An example of the data in the first format is dataset 120 (of FIG. 1). In an implementation, the specialized circuitry uses a spatial voting algorithm to divide the data of the first format into multiple spatial regions and assign a vote to each spatial region based on the collected data in a corresponding spatial region. An example of the data in the grid format is image 140 (of FIG. 1).

For data values of the dataset corresponding to one or more columns in a particular row and one or more additional rows (adjacent or non-adjacent depending on the implementation), the specialized circuitry generates a first coordinate corresponding to a running mean of the subset of data values. The specialized circuitry generates a second coordinate corresponding to a running standard deviation (or running sigma level depending on the implementation) of the subset of data values. The specialized circuitry increments a count corresponding to the region of the multiple regions of the image located by the first coordinate and the second coordinate. In an implementation, when executing the instructions of an anomaly detection driver, the specialized circuitry adjusts the counts of the multiple regions utilizing multiple weights assigned to one or more of the corresponding subset of data values and the counts. In an implementation, the specialized circuitry retrieves multiple thresholds corresponding to one or more images generated with no malware running on the first circuitry. The specialized circuitry generates an alert that indicates an anomaly when one or more of the multiple counts across the multiple regions exceed a corresponding threshold.

In some implementations, the specialized circuitry uses a data model to generate a score or other indication specifying the probability that an anomaly has occurred in the spatial region based on a vote (a count or another type of weighted value) exceeding a corresponding threshold in one or more spatial regions of the multiple spatial regions. The data model generates the scores and performs the comparisons of the scores with corresponding thresholds. In various implementations, the data model uses machine learning techniques that rely on one of a recurrent neural network (RNN) structure, a convolutional neural network (CNN) structure, a deep neural network (DNN) structure, and so forth. In some implementations, the specialized circuitry uses multiple data models with each of the multiple data models including a different type of neural network structure. The specialized circuitry combines the results of one or more data models to generate one or more indications specifying whether an anomaly has occurred. In an implementation, the specialized circuitry generates one or more weighted sums using the results of the one or more data models and compares the weighted sums to one or more thresholds. In another implementation, the specialized circuitry combines the results using one of multiple other types of calculations.

If the specialized circuitry generates an indication that the second data does not indicate an anomaly has occurred in the computing system (“no” branch of the conditional block 408), then the specialized circuitry generates an indication specifying no anomaly has occurred in the computing system (block 410). However, if the specialized circuitry generates an indication that the second data indicates an anomaly has occurred in the computing system (“yes” branch of the conditional block 408), then the specialized circuitry generates an alert to send to the first circuitry (block 412). The alert includes information about the nature of the anomaly, the location of the anomaly in the multiple spatial regions, and suggested actions to resolve the anomaly.

Turning now to FIG. 5, a generalized diagram is shown of a computing system 500 that efficiently detects attacks on a client device. The attacks can, for example, be seeking access to private user information, or otherwise. In an implementation, computing system 500 includes first circuitry 507 and second circuitry 502. In various implementations, first circuitry 507 has the same functionality as circuitry 112 (of FIG. 1) and second circuitry 502 has the same functionality as circuitry 114 (of FIG. 1). First circuitry 507 includes at least processing circuits 508 and 510. Second circuitry 502 includes at least processing circuits 504 and 506. Additionally, computing system 500 includes input/output (I/O) interfaces 520, bus 525, network interface 535, memory controllers 530, memory devices 540, display controller 550, and display device 555. In other implementations, computing system 500 includes other components and/or computing system 500 is arranged differently. For example, power management circuitry, and phased locked loops (PLLs) or other clock generating circuitry are not shown for ease of illustration. In various implementations, the components of the computing system 500 are on the same die such as a system-on-a-chip (SOC). In other implementations, the components are individual dies in a system-in-package (SiP) or a multi-chip module (MCM). A variety of computing devices use the computing system 500 such as a desktop computer, a laptop computer, a server computer, a tablet computer, a smartphone, a gaming device, a smartwatch, and so on.

In various implementations, first circuitry 507 includes circuitry that executes instructions of a copy of the operating system 542 and commands from the operating system 542. First circuitry 507 also executes tasks of a variety of types of workloads. Processing circuit 508 stores and executes instructions of operating system 509, which is a copy of at least a subset of operating system 542. Similarly, processing circuit 510 stores and executes instructions of operating system 512, which is a copy of at least a subset of operating system 542. Computing system 500 also includes second circuitry 502 that is isolated from operating system software being executed by processing circuits 508 and 510 of first circuitry 507. In this sense, second circuitry 502 is configured to execute instructions of code instead of the operating system 542 such as instructions of anomaly detection driver 503. For example, at least processing circuit 504 includes anomaly detection driver 503, which is a copy of anomaly detection driver 544 stored in memory devices 540. By being isolated from the operating system 542 and executing the instructions of the anomaly detection driver 503, second circuitry 502 is also isolated from malware targeting the first circuitry 507.

Processing circuits 508 and 510 of the first circuitry 507 are representative of any number of processing circuits which are included in computing system 500. In an implementation, processing circuit 510 is a general-purpose processing circuit, such as a central processing unit (CPU), and includes multiple general-purpose processor cores, each with one or more general-purpose pipelines that execute instructions of a particular instruction set architecture (ISA). A local memory (not shown) includes a local hierarchical cache memory subsystem of processing circuit 510. The local memory stores source data, intermediate results data, results data, and copies of data and instructions stored in memory devices 540. Examples are the operating system 512 (copy of at least a portion of operating system 542) and applications 514 (copies of at least portions of applications 545).

Processing circuit 510 is coupled to bus 525 via interface 519. In an implementation, interface 519 uses the communication protocol of a peripheral component interconnect (PCI) bus, a PCI-Extended (PCI-X), or a PCIE (PCI Express) bus. In some implementations, processing circuit 510 has a direct point-to-point (P5P) connection with processing circuit 508 that bypasses bus 525. Processing circuit 510 receives, via interface 519, copies of various data and instructions, such as a host operating system 512, one or more device drivers, one or more applications such as application 514, and/or other data and instructions.

In one implementation, processing circuit 508 is a parallel data processing circuit with a highly parallel data microarchitecture. Examples of processing circuit 508 are a graphics processing unit (GPU), a digital signal processing circuit (DSP), a field programmable gate arrays (FPGA), an application specific integrated circuit (ASIC), and so forth. Processing circuit 508 can be a discrete device, such as a dedicated GPU (dGPU), or processing circuit 508 can be integrated in the same package as another processing circuit such as processing circuit 510. In such cases, processing circuit 508 is an integrated GPU (iGPU). As described earlier, first circuitry 507 can also include a variety of other types of processing circuits and integrated circuits capable of executing instructions of operating system 542 or commands generated by the instructions of operating system 542.

In an implementation, processing circuit 504 of second circuitry 502 is one of a variety of types of a multiprocessor or multiprocessing circuit. Processing circuit 504 includes less functionality and performance than processing circuit 510 while also consuming less power. Processing circuit 504 executes instructions of anomaly detection driver 503, which is a copy of anomaly detection driver 544. In some implementations, processing circuit 506 is one of an embedded inference processing unit (EIPU) or an embedded inference processing circuit, an artificial intelligence (AI) accelerator processing circuit, an embedded neural processing unit (NPU) or an embedded neural processing circuit, a multiprocessing circuit, and so on. In some implementations, processing circuit 506 executes the anomaly detection data model 505 (or data model 505).

Data model 505 is a copy of data model 546 stored in memory devices 540. In various implementations, the data model 505 is a trained neural network used to perform machine learning for generation of one or more indications specifying whether an anomaly has occurred in computing system 500. Data model 505 uses machine learning techniques that rely on one of a recurrent neural network (RNN) structure, a convolutional neural network (CNN) structure, a deep neural network (DNN) structure, and so forth. In some implementations, processing circuit 506 uses multiple data models with each of the multiple data models including a different type of neural network structure. Processing circuit 506 combines the results of the multiple data models to generate one or more indications specifying whether an anomaly has occurred. In an implementation, processing circuit 506 generates one or more weight sums using the results of the multiple data models and compares the weight sums to one or more thresholds. In another implementation, processing circuit 506 combines the results using one of multiple other types of calculations. In various implementations, driver 503 and data model 505 do not have copies stored on memory devices 540. Rather, processing circuits 504 and 506 already store them and receive updates through network interface 535 via bus 525. Without executing instructions of operating system 542 and without executing commands generated by the instructions of operating system 542, processing circuits 504 and 506 cannot be compromised, or otherwise changed without user consent, by malware.

When executing the instructions of anomaly detection driver 503 (or driver 503), processing circuit 504 collects data indicating hardware behavior of the computing system 500. In some implementations, processing circuit 504 receives collected data stored in hardware performance counters 560 (or hardware monitors 560) located across computing system 500. Hardware monitors 560 store counts, rates, or other measurements of particular hardware events that occur across computing system 500. Examples of these hardware events are a number of cache misses at one or more levels of a cache hierarchy, a number of accesses at the one or more levels of a cache hierarchy, a number of page table walks by a processing circuit, a number of instructions fetched, decoded, or retired of a particular instruction type by a processing circuit, a number of micro-operations (micro-ops) retired by a processing circuit where the micro-ops are generated from instructions, a number of branch mispredictions by a processing circuit, a number of bytes read from or written to memory controllers 530, a number of stalls in a particular pipeline stage of a processing circuit, and so forth. The types of information captured by the hardware monitors vary from one type of processing circuit or integrated circuit to another due to the differences in the microarchitectures.

In some implementations, processing circuit 504 receives also receives power management related data. The power management related data includes measurements from one or more sensors (not shown) computing system 500. These sensors measure various operating parameters. In various implementations, these operating parameters include the operating temperature of multiple regions of the computing system 500, the amount of current drawn by one or more integrated circuits and processing circuits of the computing system 500, the power supply voltage used by one or more integrated circuits and processing circuits of the computing system 500, and so forth. The power management related data can also include a measure of utilization of one or more integrated circuits and processing circuits. The power management related data can also include a power-performance state (P-state) of one or more integrated circuits and processing circuits.

In other implementations, using network interface 535, processing circuit 504 receives power management related data from remote servers storing telemetry data corresponding to multiple client devices. This data is monitored by multiple client devices and sent as telemetry messages to the remote servers. Processing circuit 504 accesses the power management related data from the remote servers and includes it as collected data indicating hardware behavior of the computing system. The combination of the directly accessible power management related data and the remotely accessed power management related data provides a power management framework for processing circuit 504 to indicate hardware behavior of the computing system 500.

In an implementation, processing circuit 504 retrieves the above data indicating hardware behavior of computing system 500 responsive to detecting a period of time has elapsed. An indication of the period of time is stored in a programmable configuration register. In another implementation, processing circuit 504 retrieves the data indicating hardware behavior responsive to detecting an event such as a P-state change. In some implementations, when executing the instructions of the anomaly detection driver 503, processing circuit 504 organizes the collected data into a first format such as rows and columns based on the information type. Each type of information has a location reserved for it in the rows and columns of the first format. An example of this organized data is dataset 120 (of FIG. 1).

When executing the instructions of the anomaly detection driver 503, processing circuit 504 uses the organized data in the first format to generate data in a second format such as a grid format. An example of the data in the second format is image 140 (of FIG. 1). In various implementations, processing circuit 504 executes a spatial voting algorithm to generate the data in the second format. Afterward, processing circuit 504 sends the data in the second format to processing circuit 506 that executes the anomaly detection data model 505. By executing the anomaly detection data model 505 using the received data, processing circuit 506 generates an indication specifying whether the data in the second format corresponds to an occurrence of an anomaly in computing system 500. These and other steps are further described in the description of FIGS. 6-7. Before providing further description, other components of computing system 500 are described here.

In some implementations, computing system 500 utilizes a communication fabric (“fabric”), rather than the bus 525, for transferring requests, responses, and messages between the processing circuits 502 and 510, the I/O interfaces 520, the memory controllers 530, the network interface 535, and the display controller 550. When messages include requests for obtaining targeted data, the circuitry of interfaces within the components of computing system 500 translates target addresses of requested data. In some implementations, the bus 525, or a fabric, includes circuitry for supporting communication, data transmission, network protocols, address formats, interface signals and synchronous/asynchronous clock domain usage for routing data.

Memory controllers 530 are representative of any number and type of memory controllers accessible by first circuitry 507 and second circuitry 502. While memory controllers 530 are shown as being separate from first circuitry 507 and second circuitry 502, it should be understood that this merely represents one possible implementation. In other implementations, one of memory controllers 530 is embedded within one or more of first circuitry 507 and second circuitry 502 or it is located on the same semiconductor die as one or more of first circuitry 507 and second circuitry 502. Memory controllers 530 are coupled to any number and type of memory devices 540.

Memory devices 540 are representative of any number and type of memory devices. For example, the type of memory in memory devices 540 includes Dynamic Random Access Memory (DRAM), Static Random Access Memory (SRAM), NAND Flash memory, NOR flash memory, Ferroelectric Random Access Memory (FeRAM), or otherwise. Memory devices 540 store at least instructions of an operating system, one or more device drivers, and application. In some implementations, an application stored on memory devices 540 is a highly parallel data application such as a video graphics application, a shader application, or other. Copies of these instructions can be stored in a memory or cache device local to processing circuit 510 and/or processing circuit 505.

I/O interfaces 520 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB). Various types of peripheral devices (not shown) are coupled to I/O interfaces 520. Such peripheral devices include (but are not limited to) displays, keyboards, mice, printers, scanners, joysticks or other types of game controllers, media recording devices, external storage devices, and so forth. Network interface 535 receives and sends network messages across a network.

Referring now to FIG. 6, a generalized block diagram is shown of a method 600 for efficiently detecting attacks on a client device. The attacks can, for example, be seeking access to private user information, or otherwise. For purposes of discussion, the steps in this implementation (as well as in FIGS. 3 and 7) are shown in sequential order. However, in other implementations some steps occur in a different order than shown, some steps are performed concurrently, some steps are combined with other steps, and some steps are absent.

Examples of a computing device are a laptop computer, a smartphone, a gaming console, a server computer, a desktop computer, or otherwise. First circuitry of the computing device executes instructions of an operating system and commands from the operating system (block 602). Examples of the first circuitry that executes the operating system are a general-purpose processing circuit, such as a central processing unit (CPU), a parallel data processing circuit, such as a graphics processing unit (GPU), a digital signal processing circuit (DSP), a field programmable gate arrays (FPGA), an application specific integrated circuit (ASIC), input/output (I/O) peripheral devices and controllers, fixed-function integrated circuits, and so forth. In various implementations, the first circuitry has the same functionality as circuitry 112 (of FIG. 1) and first circuitry 507 (of FIG. 5).

The client device also includes second circuitry that is isolated from operating system software being executed by the CPU of the first circuitry. In this sense, the second circuitry is configured to execute instructions of code instead of the operating system such as instructions of an anomaly detection driver (block 604). In various implementations, the second circuitry is anomaly detection circuitry. Examples of anomaly detection circuitry are an embedded inference processing unit (EIPU) or an embedded inference processing circuit, an artificial intelligence (AI) accelerator processing circuit, an embedded neural processing unit (NPU) or an embedded neural processing circuit, a multiprocessing circuit, and so on. In various implementations, the second circuitry has the same functionality as anomaly detection circuitry 114 (of FIG. 1) and second circuitry 502 (of FIG. 5).

The second circuitry collects data from hardware performance counters of the computing device (block 606). The hardware performance counters (or hardware monitors) are located across one or more integrated circuits and processing circuits of the client device. These hardware monitors store counts, rates, or other measurements of particular hardware events that occur over time as the first circuitry executes tasks. Examples of these hardware events are a number of cache misses at one or more levels of a cache hierarchy, a number of accesses at the one or more levels of a cache hierarchy, a number of page table walks by a processing circuit, a number of instructions fetched, decoded, or retired of a particular instruction type by a processing circuit, a number of micro-operations (micro-ops) retired by a processing circuit where the micro-ops are generated from instructions, a number of branch mispredictions by a processing circuit, a number of bytes read from or written to a memory controller, a number of stalls in a particular pipeline stage of a processing circuit, and so forth. The types of information captured by the hardware monitors vary from one type of processing circuit or integrated circuit to another due to the differences in the microarchitectures.

The second circuitry collects data that includes power management related data from one or more of sensors of the computing system (block 608). The power management related data includes measurements from one or more sensors located across one or more integrated circuits and processing circuits of the computing device. These sensors measure the operating temperature of multiple regions of the computing device. These sensors also measure the amount of current drawn by one or more integrated circuits and processing circuits of the computing device. The power management related data can also include a measure of utilization of one or more integrated circuits and processing circuits. The power management related data can also include a power-performance state (P-state) of one or more integrated circuits and processing circuits. The P-state includes an indication (e.g., P0, P1, and so on) that indicates at least an operating power supply voltage and an operating clock frequency of a corresponding integrated circuit.

The second circuitry collects data that includes power management related data from remote servers storing telemetry data of multiple devices using the same computing system or system architecture as the computing device (block 610). This data is monitored and recorded by multiple client devices using the same system architecture and then sent as telemetry messages to the remote servers. In an implementation, the second circuitry retrieves the above data indicating hardware behavior responsive to detecting a period of time has elapsed. An indication of the period of time is stored in a programmable configuration register. In another implementation, the second circuitry retrieves the data indicating hardware behavior responsive to detecting an event such as a P-state change.

The second circuitry organizes the collected data using a data format (block 612). In some implementations, when executing the instructions of an anomaly detection driver, the second circuity organizes the collected data into a data format such as rows and columns based on the information type. Each type of information has a location reserved for it in the rows and columns of the first format. An example of this organized data is dataset 120 (of FIG. 1). The second circuitry generates an image by executing a spatial voting algorithm using the collected and organized data (block 614). An example of the image in the grid format is image 140 (of FIG. 1). The second circuitry sends the image to an evaluator to generate an indication specifying whether the image corresponds to an anomaly in the computing device. A further description of these subsequent steps is provided in the below description of method 700 (of FIG. 7).

Referring now to FIG. 7, a generalized block diagram is shown of a method 700 for efficiently detecting attacks on a client device. The attacks can, for example, be seeking access to private user information, or otherwise. Examples of a client device are a laptop computer, a smartphone, a gaming console, a server computer, a desktop computer, or otherwise. First circuitry of the client device executes instructions of an operating system and commands from the operating system (block 702). In various implementations, the first circuitry has the same functionality as circuitry 112 (of FIG. 1) and first circuitry 507 (of FIG. 5). The client device also includes second circuitry that is isolated from operating system software being executed by at least the CPU of the first circuitry. In this sense, the second circuitry is configured to execute instructions of code instead of the operating system such as instructions of an anomaly detection driver (block 704). In various implementations, the second circuitry has the same functionality as anomaly detection circuitry 114 (of FIG. 1) and second circuitry 502 (of FIG. 5).

The second circuitry generates image data in a grid format indicating hardware behavior of the computing system (block 706). In various implementations, the second circuitry performs the steps of method 600 (of FIG. 6) to generate the image data. When executing the instructions of the anomaly detection driver, the second circuitry evaluates the image data (block 708). In some implementations, the second circuitry utilizes an anomaly detection data model that uses machine learning techniques that rely on one of a recurrent neural network (RNN) structure, a convolutional neural network (CNN) structure, a deep neural network (DNN) structure, a feed-forward neural network with one hidden layer, and so forth. In various implementations, the second circuitry executes instructions of the anomaly detection data model. Therefore, the anomaly detection data model cannot be compromised, or otherwise changed without user consent, by malware. In some implementations, the second circuitry uses multiple data models with each of the multiple data models including a different type of neural network structure. The second circuitry combines the results of the multiple data models to generate one or more indications specifying whether an anomaly has occurred. In an implementation, the second circuitry generates one or more weight sums using the results of the multiple data models and compares the weight sums to one or more thresholds. In another implementation, the second circuitry combines the results using one of multiple other types of calculations.

The second circuitry receives an output from the anomaly detection data model (block 710). In an implementation, the anomaly detection data model provides a single score providing an indication specifying whether the image data corresponds to an anomaly in the computing system. In another implementation, the anomaly detection data model provides multiple scores that can be combined as a weighted sum or other combination to evaluate whether the image data corresponds to an anomaly in the computing system. The one or more scores can also indicate a type of anomaly that has been detected in the computing system. If the output does not indicate an anomaly occurring in the computing system (“no” branch of conditional block 712), then the second circuitry generates a message specifying typical operation by the computing system (block 714). The second circuitry sends the message to the first circuitry (block 716). However, if the output indicates an anomaly has occurred in the computing system (“yes” branch of conditional block 712), then the second circuitry generates an alert (e.g., an interrupt or other indication) that indicating the anomaly has occurred in the computing system (block 718). The second circuitry sends the interrupt to the first circuitry (block 720).

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high-level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware-based type emulator from such vendors as Cadence®, EVE®, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is

1. An apparatus comprising:
circuitry configured to:
collect telemetry data comprising measurements of power consumption and hardware events that occur over time as one or more processing circuits execute tasks;
encode the telemetry data as an image based on a spatial voting algorithm; and
convey the image to a neural network structure configured to output anomaly indicators based on images that depict statistical information, wherein the neural network structure is configured to generate a prediction that malware has executed on the one or more processing circuits based on the image.

2. The apparatus as recited in claim 1, wherein the circuitry comprises a neural processing circuit isolated from malware that can execute on the one or more processing circuits.

3. The apparatus as recited in claim 2, wherein the neural processing circuit is configured to generate weights of the neural network structure during training of the neural network structure that utilizes unsupervised learning, wherein the training of the neural network structure uses a plurality of images based on statistical features of the telemetry data collected over time.

4. The apparatus as recited in claim 3, wherein the weights of the neural network structure are based on an architecture of the one or more processing circuits.

5. The apparatus as recited in claim 3, wherein the neural processing circuit is configured to convey the image to the neural network structure as a plurality of regions of a grid, wherein one or more regions comprise one or more indicators of a number of statistical features pairs corresponding to the telemetry data mapped to the region.

6. The apparatus as recited in claim 1, wherein the telemetry data comprises one or more of an operating temperature, an operating power supply voltage or current drawn by the one or more processing circuits.

7. The apparatus as recited in claim 1, wherein the hardware events comprise data stored in performance counters corresponding to one or more of cache misses at one or more levels of a cache hierarchy, a number of instructions retired, or a number of bytes read from or written to a memory controller.

8. A method, comprising:
collecting, by circuitry, telemetry data comprising measurements of power consumption and hardware events that occur over time as one or more processing circuits execute tasks;
encoding, by the circuitry, the telemetry data as an image based on a spatial voting algorithm; and
conveying, by the circuitry, the image to a neural network structure, wherein the neural network structure is configured to generate a prediction that malware has executed on the one or more processing circuits based on the image.

9. The method as recited in claim 8, wherein the circuitry comprises a neural processing circuit isolated from malware that can execute on the one or more processing circuits.

10. The method as recited in claim 9, further comprising generating, by the neural processing circuit, weights of the neural network structure during training of the neural network structure that utilizes unsupervised learning, wherein the training of the neural network structure uses a plurality of images based on statistical features of the telemetry data collected over time.

11. The method as recited in claim 10, wherein the weights of the neural network structure are based on an architecture of the one or more processing circuits.

12. The method as recited in claim 10, further comprising conveying, by the neural processing circuit, the image to the neural network structure as a plurality of regions of a grid, wherein one or more regions comprise one or more indicators of a number of statistical features pairs corresponding to the telemetry data mapped to the region.

13. The method as recited in claim 8, wherein the telemetry data includes data indicative of power consumption, the data comprising one or more of an operating temperature, an operating power supply voltage or current drawn by the one or more processing circuits.

14. The method as recited in claim 8, wherein the hardware events comprise data stored in performance counters corresponding to one or more of cache misses at one or more levels of a cache hierarchy, a number of instructions retired, or a number of bytes read from or written to a memory controller.

15. A computing system comprising:
a memory comprising circuitry configured to store data;
a first processing circuit; and
a second processing circuit; and
wherein the first processing circuit is configured to:
execute instructions of an operating system stored on the memory; and
execute tasks of an application stored on the memory; and
wherein the second processing circuit is configured to:
collect telemetry data comprising measurements of power consumption and hardware events that occur over time as the first processing circuit executes the tasks; and
encode the telemetry data as an image based on a spatial voting algorithm; and
convey the image to a neural network structure configured to output anomaly indicators based on images that depict statistical information, wherein the neural network structure is configured to generate a prediction that malware has executed on the first processing circuit based on the image.

16. The computing system as recited in claim 15, wherein the second processing circuit is a neural processing circuit isolated from malware that can execute on the first processing circuit.

17. The computing system as recited in claim 16, wherein the neural processing circuit is configured to generate weights of the neural network structure during training of the neural network structure that utilizes unsupervised learning, wherein the training of the neural network structure uses a plurality of images based on statistical features of the telemetry data collected over time.

18. The computing system as recited in claim 17, wherein the weights of the neural network structure are based on an architecture of the first processing circuit.

19. The computing system as recited in claim 17, wherein the neural processing circuit is configured to convey the image to the neural network structure as a plurality of regions of a grid, wherein one or more regions comprise one or more indicators of a number of statistical features pairs corresponding to the telemetry data mapped to the region.

20. The computing system as recited in claim 15, wherein the telemetry data comprises one or more of an operating temperature, an operating power supply voltage or current drawn by the first processing circuit.
